(19) United States
(12) Patent Application Publication
(10) Pub. No.: US 2008/0250910 A1
(43) Pub. Date: Oct. 16, 2008

(54) Machine for making music

(76) Inventor: Horace Greely Thornhill, Crossville, TN (US)

Correspondence Address: HORACE GREELY THORNHILL, 117 APPLE CIRCLE, CROSSVILLE, TN, 38555, US

(21) Appl. No.: 12/080,704

(22) Filed: Apr. 5, 2008

Related U.S. Application Data
(60) Provisional application No. 60/923,683, filed on Apr. 16, 2007.

(51) Int. Cl. G10D 3/02

(52) U.S. Cl. 84/294

(57) ABSTRACT

A stringed musical instrument, such as but not limited to a guitar, whose sides are angled to produce a speaker cone effect; and without standard relief holes in the instrument's top; with the absence of a standard hole on the instrument's top that allows more sound to be produced by the remaining material in the top; whose relief holes are located on the “inner back” that is attached to the angled sides; that embodies a second, or “outer back,” identically contoured or shaped like the inner back but whose outer dimensions are equal to the outer dimensions of the instrument's top, with a sound chamber created by the proximity of the inner back with the outer back, whose outer back embodies a shaped flange designed to direct the instrument's sound forward, and embodies a series of springs attached to both the bridge plate and inner back of the instrument, designed to create a reverb effect.

### CROSS REFERENCE TO RELATED APPLICATIONS

This application is based on provisional application Ser. No. 60923683, filed on Apr. 16, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of music and more specifically to a machine for making music. Historical documentation of stringed instruments dates back to the Biblical harp. Centuries later, other stringed instruments appeared, such as the lute and the violin. These instruments and all those prior instruments were strung with animal sinew or processed animal gut. In recent times, the guitar, mandolin, and banjo appeared. The earliest versions of these instruments also utilized animal sinew or gut. These were and are known as classical instruments.

Within the past one-hundred years, guitars and other acoustic instruments began to appear with metal strings. These metal strings had the effect of producing a higher volume of sound with fuller frequency response. Within the guitar realm, two of these instruments emerged as standards: the flat top guitar with a “round” hole and the arch top guitar with the “F” hole. The flat top guitar evolved into what is known as an open chord rhythm instrument, as well as a flat picking lead instrument; while the arch top guitar evolved into the closed chord instrument, used in the beginning for closed chord rhythm instrument which evolved into an electric lead instrument. Many of both types of instruments were outfitted with electronic devices such as pickups and amplifiers, designed to increase the volume.

While modern instruments have embodied vast improvements over their predecessors, they nevertheless have embodied and still do embody severe deficiencies. The arch top guitar lacked the ringing sound of the flat top guitar and produced limited volume compared to its counterpart. While the flat top guitar produced more volume and a brighter sound, it nevertheless has always had certain shortcomings which include: a loss of frequency response on the bass strings; a distinct loss of volume in certain frequencies and on certain strings; an inability to produce omnidirectional sound at certain frequencies and from certain strings; a mushiness, particularly on the bass strings, that causes the instrument to get “lost” when used with certain types of musical groups or bands because of the instrument's inability to “cut through” the sound of other instruments. Furthermore, the sound from this type instrument is projected mostly forward; therefore the musician hears a much lower volume of sound than the audience. This makes soloing difficult for the musician who is surrounded by other instruments that are individually and collectively designed to produce more volume.

### BRIEF SUMMARY OF THE INVENTION

The primary object of the invention is that it is designed to produce a higher volume of sound.

Another object of the invention is that it is designed to produce more complete range of frequencies.

Another object of the invention is that its design embodies additional beneficial features to standard instruments designs without infringing on or compromising the standard dimensions of the given instrument.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for making music comprising: A stringed musical instrument, such as but not limited to a guitar; whose sides are angled to produce a speaker cone effect; without standard relief holes in the instrument's top; whereby the absence of the standard placement of the sound hole on the instrument's top allows more sound to be produced by the material that remains on the soundboard; whose primary relief hole(s) are located on the “inner back”; that embodies a second, or “outer back,” contoured or shaped like the inner back; with a sound chamber created by the proximity of the inner back with the outer back; whose outer back embodies a shaped flange designed to direct the instrument's sound omni directionally, and whereby a series of springs attached to both the bridge and inner back of the instrument extends the length of sounds and creates a reverb effect.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a frontal or top view of Prior Art of the invention.

FIG. 2 is a rear view of Prior Art of the invention.

FIG. 3 is a frontal or top view of the Preferred Embodiment of the invention.

FIG. 4 is a rear view of the Preferred Embodiment of the invention.

FIG. 5 is the inner back of the Preferred Embodiment of the invention.

FIG. 6 is a rear view of the inner back of the Preferred Embodiment of the invention.

FIG. 7 is an inside view of the outer back of the Preferred Embodiment of the invention.

FIG. 8 is a rear view of the outer back, unattached, of the Preferred Embodiment of the invention.

FIG. 9 is a rear view of the outer back, attached, of the Preferred Embodiment of the invention, and a breakout from FIG. 9.

### ABSTRACT OF THE DISCLOSURE

A stringed musical instrument, such as but not limited to a guitar, whose sides are angled to produce a speaker cone effect; and without standard relief holes in the instrument's top; with the absence of a standard hole on the instrument's top that allows more sound to be produced by the remaining material in the top; whose relief holes are located on the “inner back” that is attached to the angled sides; that embodies a second, or “outer back,” identically contoured or shaped like the inner back but whose outer dimensions are equal to the outer dimensions of the instrument's top, with a sound chamber created by the proximity of the inner back with the outer back, whose outer back embodies a shaped flange designed to direct the instrument's sound forward, and embodies a series of springs attached to both the bridge plate and inner back of the instrument, designed to create a reverb effect.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

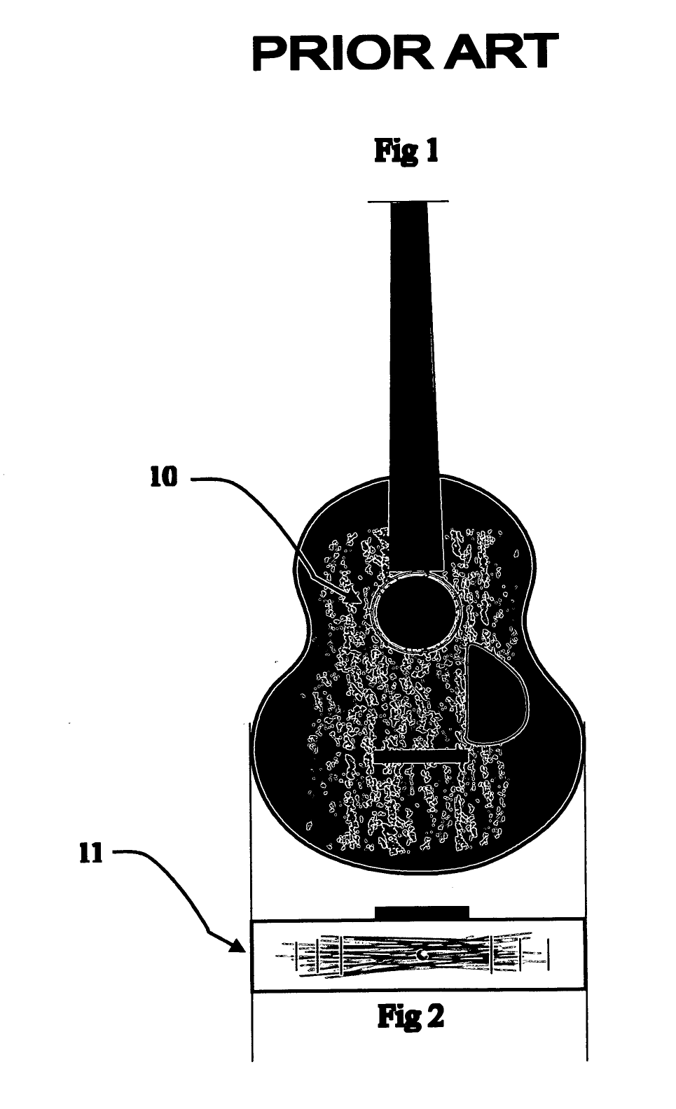

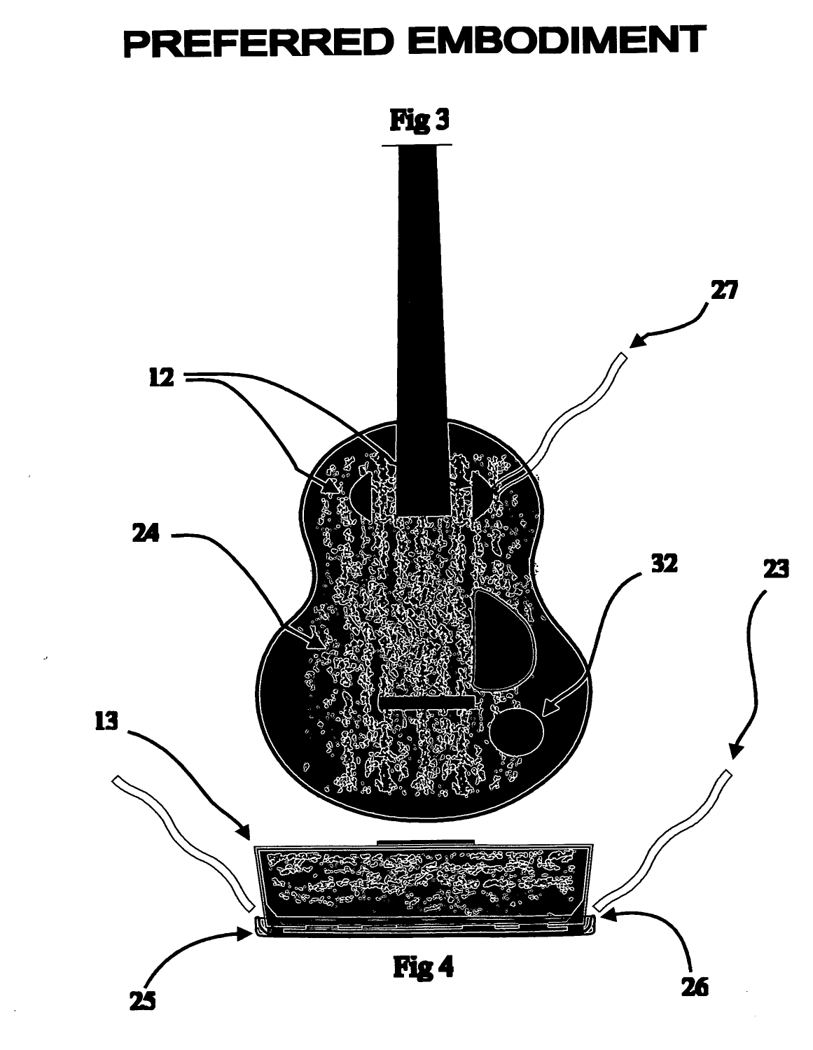

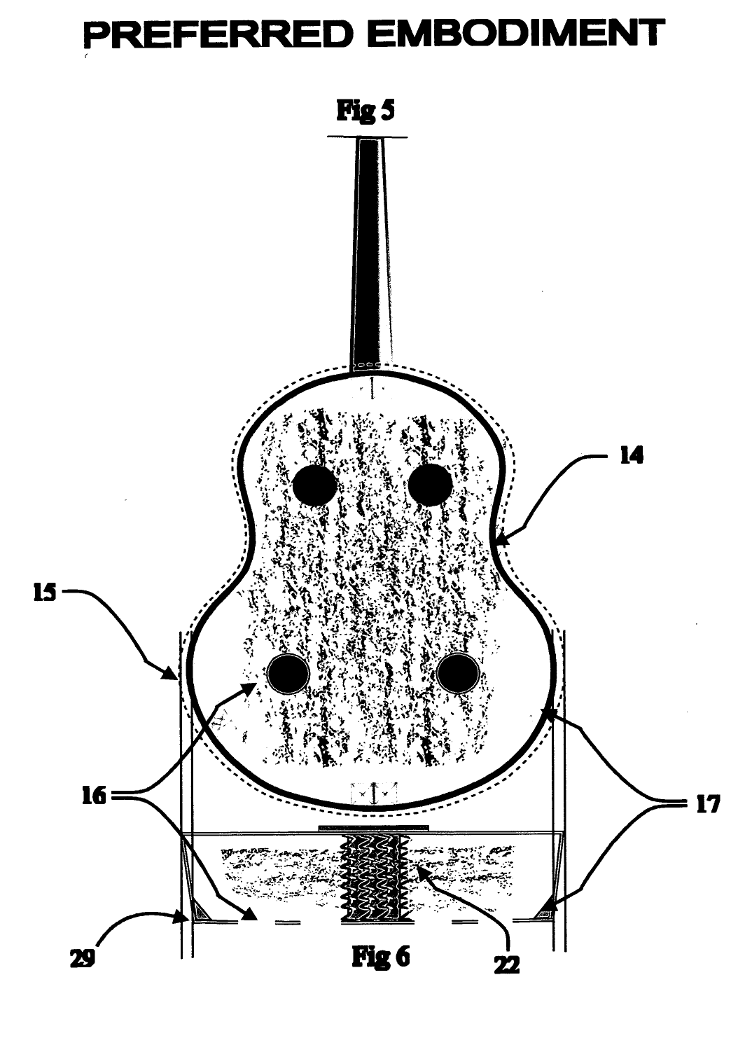

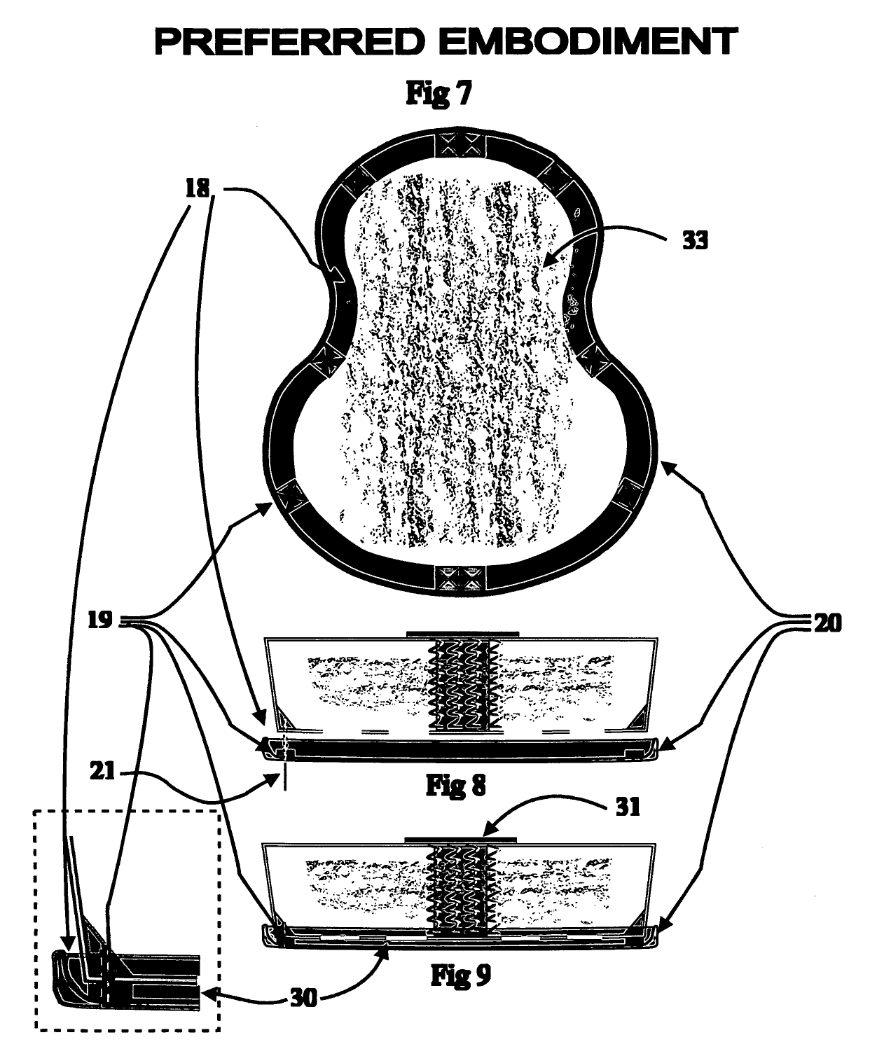

Turning to FIG. 1, Number 10 illustrates the top of an instrument produced with prior art. The opening in the top of the instrument is calculated to cause the instrument to “pump” when the strings are plucked or strummed. This pumping action, generated by the vibration of the strings against the bridge, which is then transmitted to the soundboard, or top of the instrument, forces sound energy out of the hole and projects it forward. FIG. 2 number 11, shows a rear view of the prior art. Note that the sides of the instrument are perpendicular with the top of the instrument. Turning now to FIG. 3 of the preferred embodiment of the invention, note that the top of the invention is essentially the same as shown on the prior art, with the exception of the placement of the holes. However, turning to FIG. 4, it can clearly be seen from the rear view of the invention that the sides, number 13, of the invention are set at an angle. This angle may be more or less, depending on the amount of compression of the sound waves, or music, desired. Turning to FIG. 5, number 16 depicts holes in the inner back of the invention. These holes are calculated to allow some but not all of the compressed sound to escape from the inner body of the invention. Number 15, the dotted line, shows the dimensions of the top, FIG. 3 number 24, relative to the outside dimensions of the inner back, FIG. 6, number 29. Turning back to FIG. 4, note that the outer dimensions of the outer back, number 25, is essentially the same as the top, or soundboard, FIG. 3 number 24, of the invention. The difference in size between the outer dimensions of the top, number 24, and the outside dimensions of the inner back, FIG. 4 number 13, provides an opening all the way around the invention, number 26, which allows compressed sound, number 23, to be emitted all the way around the invention. Turning now to FIG. 7, the outer back of the invention, number 33, is shown. The outer back is shaped to match the shape of the inner back. As the inner back and the outer back reside in proximity, this provides a sound chamber that distributes the sound evenly all around the invention. FIG. 8 depicts a rear view of the invention with the outer back unattached. Number 19 depicts spacers, which hold the outer back away from the inner back at an indeterminate distance, depending on the volume and tone desired. Number 17 of FIGS. 5 and 6 shows the posts which are attached to both the inner sides and the inside of the inner back, through which fasteners, FIG. 8 number 21, are passed for the purpose of securing the outer back to the inner back. FIG. 9 depicts the outer back fastened to the inner back of the invention. FIGS. 7 and 8 number 18, depicts a flange, fluted on the inside, that completely encircles the invention. This fluted shape is designed to project the sound omni directionally. The space between the inner back and the outer back, the sound chamber, may be made wider or narrower to effect the tone (base and treble) of the sound emitted from the opening or sound chamber, number 26. FIG. 6 number 22, depicts springs that are attached to the underside of the bridge or bridge plate, number 31, for the purpose of extending the resonance of the invention, and for adding a reverb effect to the sound. Returning now to FIG. 3, number 27 depicts relief sound emitted from small hole(s), number 12, in the top or soundboard of the invention. This is necessary because the angled sides create a speaker cone effect, in reverse. This causes inordinate compression of low frequencies, which overpower the high frequencies as they are forced out the holes on the inner back, number 16, and then emitted from the sound chamber, number 26. The small hole(s), which may be of indeterminate size and or placement, number 12, are strategically placed to allow high frequencies, number 27, to escape, thereby affecting a balance of the overall frequencies produced by the plucking or strumming of the strings. Holes of different sizes and placement may be utilized to affect egression and balance of certain frequencies. For example, should a bass instrument be desired, a larger hole(s) might be strategically placed at another position on the soundboard, FIG. 3 number 32. In such a design, the smaller hole(s) may or may not be desirable.

The embodiment of this invention may also be applied to other instruments, such as, but not limited to, violins, mandolins, pianos, steel guitars, bass guitars, etc. Furthermore, while these instruments are typically made of wood, certain components of the invention might also be made from, but not limited to, inorganic elements, such as plastic, fiberboard, or metal, etc. For example, the inner back might be made from metal for a more brash sound, or fiberboard to affect yet a different tone or an increase in volume. The outer back might be made of fiberboard to achieve a lighter instrument.

What is claimed:

1. A machine for making music comprising a musical instrument:
whose sides are angled so the interior portion of the invention produces a speaker cone effect;
whose top is without standard relief holes;
whose inner back contains relief holes;
whose outer back is designed to project musical sounds omni directionally;
whose relief holes in the invention's top are calculated to specifically emit certain frequencies, thereby complementing the inner back relief holes for a more balanced musical sound relative to the overall frequencies projected by the invention;
whose inner back and outer back, similarly shaped, reside in such a proximity of indeterminate spacing so as to constitute a sound chamber;
whose bridge and inner back share a set of coil, stretch, tension springs between them for the purpose of extending musical notes and producing a reverb effect;
whose inner back may be constructed of various metals for the purpose of affecting the volume or tone of the invention.

2. The machine of claim 1 wherein the invention is a stringed musical instrument such as, but not limited to an acoustical guitar.

3. The machine of claim 1 wherein the invention has angled sides that compress musical sounds generated by the soundboard of the machine, whose angles may be changed in order to affect more or less compression of the sound generated by the invention.

4. The machine of claim 1 wherein the invention has an inner back and an outer back residing in proximity in such a way as to constitute a sound chamber, and whose proximity may be changed to affect the volume and tone of the invention.

5. The machine of claim 1 wherein the invention has a fluted flange on the outer rim of the outer back which directs and projects the emitted sound omni directionally.

6. The machine of claim 1 wherein the invention has holes in the soundboard of the invention designed to provide additional relief and complement the compressed sound emitted from the sound chamber of the invention, thereby combining to constitute a full range of musical frequencies. Additionally, these holes are designed and strategically placed so as to project the sound in a more forward direction.

7. The machine of claim 1 wherein the invention may utilize strategic placement of holes on the top or soundboard of the invention to complement different design types of musical instruments. For example: placement of a hole on the bass side of the top or soundboard in the creation of an acoustical bass guitar.

8. The machine of claim 1 wherein the invention may utilize different configurations and placement of holes on the inner back to defuse and distribute the sound differently, as well as have an effect on the tone generated by the invention.

9. The machine of claim 1 wherein certain types of materials may be placed strategically in the sound chamber to control the tone and volume of the frequencies the sound chamber emits. For example: some material might be placed on the large end of the sound chamber to dampen or increase a given range of frequencies.

10. The machine of claim 1 wherein certain tension springs are stretched between the bridge plate and the inner back of the invention to extend the length of the sounds generated by the soundboard, and for the purpose of creating a reverb effect.

11. The machine of claim 1 wherein certain metals, such as stainless steel, or some other material, may be used in place of conventional material on the inner back in order to drastically change the characteristics of the sound.
